(19) United States
(12) Patent Application Publication
(10) Pub. No.: US 2009/0103801 A1
(43) Pub. Date: Apr. 23, 2009

(54) Separation of Spectrally Overlaid or Color-Overlaid Image Contributions in a Multicolor Image, Especially Transmission Microscopic Multicolor Image

(75) Inventor: Peter Messler, Mering (DE)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: OLYMPUS SOFT IMAGING SOLUTIONS GMBH, Muenster (DE)

(21) Appl. No.: 11/920,208

(22) PCT Filed: May 18, 2006
(86) PCT No.: PCT/EP2006/004731

§ 371 Date: Nov. 9, 2007

(30) Foreign Application Priority Data
May 18, 2005 (DE) 10 2005 022 880.1

(51) Int. Cl. G06K 9/00

(52) U.S. Cl. 382/163

(57) ABSTRACT

In one embodiment, the invention relates to a method for generating several single-color images from a multicolor image of a sample or object defined by intensity pixels (I_{α}(x,y), I_{β}(x,y), I_{γ})(x,y)) of at least two color channels (α, β, γ) in order to identify properties of structures of the object or sample or/and identify inherent colors of the object or sample or colors added thereto by a coloring treatment. The single-color images are defined by intensity pixels of only one of the color channels, intensity pixels of several of the color channels having the same intensity ratio among the color channels for all intensity pixels, or intensity pixels of only one resulting color channel that corresponds to a defined combination of the color channels. The multicolor image at least for the intensity pixels of at least one group of intensity pixels is based on an overlay of overlay contributions that are assigned to different original colors, especially at least approximately additive intensity contributions or intensity percentages or/and at least approximately subtractive intensity contributions or intensity percentages. According to the invention, the single-color images represent overlay contributions allocated to different original colors and are generated based on hypothetical or predefined characteristic intensity ratios or characteristic intensity ratios obtained from a calibration or derived from the multicolor image, said characteristic intensity ratios representing ratios between at least two intensity contributions or intensity percentages which are assigned to another one of the color channels, respectively, and are associated with the same property or structure of the object or sample or the same color of the object or sample.

The invention relates generally to the separation of image contributions which are spectrally superimposed or colour-superimposed on one another or mixed with one another in a multicolour image, for example of objects or object regions of various colours, especially in microscopic transmission images.

Computing methods for the spectral separation of image data have been considered or used in various contexts for a relatively long time. A method originating from 1989 (Boardman 1989) concerns the analysis of aerial photographs using what is known as singular value decomposition. Known spectra are approximated using mathematical methods to the measured “mixed spectrum” of a sample of unknown composition to determine the contributions of the individual components.

Methods of this type have also been applied in fluorescence microscopy. In an article published in 1996 (Malik, Z. et al.: Fourier transform multipixel spectroscopy for quantitative cytology, J. Microsc. 182: 133 to 140, 1996), Malik et al. describe an application relating specifically to an imaging Fourier spectrometer. An overview article from 1998 (Farkas, D. L. et al.: Non-invasive image acquisition and advanced processing in bioimaging: Computerized Medical Imaging and Graphics 22, 89 to 102, 1988) describes a method of this type, which is referred to as linear unmixing, as a method for spectral separation. Various methods and means for generating spectrally differing images (such as bandpass filters, acousto-optical filters, liquid crystal filters, interferometers) and analysis methods are dealt with.

Methods of this type for spectral separation are also conventional in confocal microscopy. cf. for example commercial applications from Zeiss, Olympus, Leica and Biorad. Reference may be made specifically to accounts of application in confocal microscopy in publications from Zeiss and also to the following publications: H. Bauch: 3D deconvolution in microscopic applications, Imaging & Microscopy 1/10, 1999; R. M. Levenson and C. C. Hoyt: Spectral imaging and microscopy, Am. Lab. 32: 26 to 34, 2000; M. E. Dickinson, G. Bearman, S. Tille, R. Lansford and S. E. Fraser: Multi-spectral imaging and linear unmixing add a whole new dimension to laser scanning fluorescence microscopy, Biotechniques 31: 1272 to 1278, 2001.

DE 199 15 137 C2 relates to a “Method for quantifying a plurality of fluorochromes in a multiply dyed sample in fluorescence microscopy and uses of the method”. This patent, which explicitly distances itself from conventionally used “ratio methods”, relates to a specific mathematical separation of relative contributions of individual fluorochromes from recorded fluorescence intensities, namely using a multivariate linear regression analysis. A “ratio method”, which according to the account in DE 199 15 137 C2 is thus conventional, is described in U.S. Pat. No. 4,603,209. The separation of four different fluorochromes in fluorescence-assisted DNA sequencing in the thus conventional manner by solving a system of linear equations is described in EP 0 294 524 A1.

With regard to the technical background or specific applications of methods of this type, reference may also be made to: Ellenberg J., Lippincott-Schwartz J., Presley J. F.: Two-color green fluorescent protein time-lapse imaging, Biotechniques 25; 183 to 846, 1998; Ellenberg J., Lippincott-Schwartz J., Presley J. F.: Dual-colour imaging with GFP variants, Trends Cell Biol., 9(2): 52 to 56, 1999; Farkas D. L., et al.: Optical image acquisition, analysis and processing for biomedical applications, in 9^{th} International Conference on Image Analysis and Processing, Florence, Italy 1997, 11663 to 11671; Garini Y et al.: Signal to noise analysis of multiple color fluorescence imaging microscopy, Cytometry 35(3): 214 to 226, 1999; Levenson M. R., Hoyt C. C.: Spectral imaging and microscopy, American Laboratory 2000: pp. 1 to 4 and Speicher M. R., Ward D. C.: The coloring of cytogenetics, Nature Med. 2: 1046 to 1048, 846, 1996.

Documents EP 0 899 558 A2; WO 94/18547; EP 0 814 594 A2; WO 97/19342; EP, 0 967 477 A1; EP 1 091 205 A2; EP 1248 132 A2; WO 95/13527; WO 96/28084; WO 97/32197; WO 01/13079 A1; WO 01/25779 A2; WO 01/38856 A1 and WO 02/08732 A1 might thus also be of interest, at least as technical background and relating generally to “Fluorescence-based measuring and analysis methods”.

Olympus BioSystems GmbH was the first to use a computing method of this type commercially, for the spectral separation of various fluorescence contributions in wide-field fluorescence microscopy. In wide-field imaging, the entire image field is typically illuminated at a suitable wavelength and the entire emitted fluorescence of the image is then recorded using a camera, in particular a CCD camera, in a “photograph”. As also in the other applications in other contexts, a spectral mixture of various fluorescence contributions of various substances is separated using a computing method (methods of this type are referred to in the various relevant publications inter alia by the terms “pixel unmixing”, “spectral unmixing”, “spectral deconvolution”, etc.). In principle, there must be provided reference spectra of the individual fluorescent substances, on the basis of which recorded mixed spectra can then be “unmixed”.

This allows dyes having markedly overlapping emission spectra to be jointly recorded, while the contributions of the individual fluorochromes to the overall fluorescence can then be calculated. An example of a suitable procedure in wide-field fluorescence microscopy on biological samples and the spectral evaluation based on the GFP and YFP (or eGFP and eGPF) combination of fluorochromes will be given hereinafter:

### 1. Recording of Reference/Calibration Images:

A respective image for merely “GFP-labelled” and for merely “YFP-labelled” cells is recorded with the same excitation (for example, 480 nm for the GFP/YFP combination) at two emission wavebands (using bandpass filters, for example 510 nm+/−10 nm, 540 nm+/−10 nm). There are thus obtained images GFP_em1, GFP_em2, YFP_em1, YFP_em2 from which the relationships K_GFP=GFP_em1/GFP_em2 and K_YFP=YFP_em1/YFP_em2 may be calculated. These relationships are a pure fluorochrome property and are in very good approximation, irrespective of the presence of a further dye or label, even in the case of markedly overlapping excitation/emission spectra of the fluorochromes involved. Alternatively, various excitation wavelengths and the same emission bands may also be used.

### 2. Recording of the Relevant Images in the Experiment Itself

Images containing simultaneously present GFP and YFP fluorochromes are recorded in the emission bands mentioned under 1. or—if the diversity of the fluorescence response was generated by differing excitation conditions—in a common emission band. There is obtained a respective mixture of the fluorescences of both fluorochromes, EM_1, EM_2:

EM_{—}1=GFP_{—}em1+YFP_{—}em2

EM_{—}2=GFP_{—}em2+YFP_{—}em2

The individual contributions GFP_em1, YFP_em1, GFP_em2 and YFP_em2 can then be calculated using the coefficients K_GFP and K_YFP described under 1. The following may be deduced:

GFP_{—}em1=K_{—}GFP*(EM_{—}1−K_{—}YFP*EM_{—}2)/(K_{—}GFP−K_{—}YFP)

All the variables on the right-hand side of this equation are now measured variables, so GFP_em1 may easily be calculated. Corresponding formulae may also be specified for the other variables: GFP_em2, YFP_em1, YFP_em2. The respective overall intensity may then be calculated simply from GFP_em1+GFP_em2 or YFP_em1+YFP_em2.

### 3. Possible Simplification of the Method:

If the images described under 2. contain regions which definitely contain only one of the fluorochromes, it would be conceivable to determine the necessary coefficients K_GFP. K_YFP from these regions. Recording of reference images would then not be necessary.

### 4. Possible Extension of the Method:

This method can, in principle, easily be extended to, for example, three or more (theoretically N) dyes: images would accordingly have to be recorded at, for example, three or more (theoretically N) emission wavelengths.

### 5. Limitation/Scope of Application:

The only property of a fluorochrome that enters into the calculation is the ratio of various fluorescences of the fluorochrome. The diversity can be generated either by the selection of various emission wavelength bands (bands in the narrower sense, by bandpass selection [for example, using long-pass filters] or in the broader sense, by LP selection [for example, using long-pass filters]) or various excitation wavebands. The important thing for the separation of various fluorochromes is that the corresponding quotients differ from one another. Nevertheless, even for fluorochromes, some of which overlap to a very high degree, it should be very easy to find a pair of excitation and/or emission wavelength bands.

The premise, which is factually entirely correct, for this analysis method, which was thus proposed in detail for the first time in relation to wide-field fluorescence microscopy, and the various conventional implementations in the prior art in other contexts is that the fluorescence intensities enter into the detection and analysis additively, with a linear relationship between the intensity of the excitation wavelengths, the resulting fluorescence intensities and the detected intensities containing fluorescence contributions of a plurality of fluorochromes. Although saturation effects in the detection and in the excitation and interactions between various fluorochromes are conceivable, in practice they do not play a major role. “Spectral unmixing” therefore not only provides qualitative information but also allows quantification of the spectrally overlapping fluorochromes.

Insofar as images which are recorded by fluorescence microscopy and show contributions of a plurality of fluorochromes (cf. point 2 of the foregoing account) and images which result from the “unmixing” and show merely the fluorescence emission of each fluorochrome have been represented in false colours on a screen, the unmixing was carried out on the basis of a plurality of images which are recorded at various excitation wavelengths or detection wavelengths, contain merely pixel-by-pixel intensity information in relation to a detection wavelength band and may thus be referred to, in the case of a false colour representation, as a single-colour image. Combining single-colour images of this type, in such a way that the single-colour images are superimposed one on top of another, in a multicolour image which is to be displayed on a screen and is defined by intensity pixels of at least two colour channels, in particular three colour channels, could be considered at most for overview purposes. In order to avoid additional costs and in view of losses of information in the multicolour image in relation to the original images according to the approaches of the prior art, the fluorescence contributions originating from various fluorochromes would in such a case certainly be unmixed on the basis of the original single-colour images.

The inventor, on the other hand, has found that a type of spectral or colour unmixing is possible even in relation to a multicolour image, defined by intensity pixels of at least two colour channels, of an object or a sample for identifying properties or structures of the object or the sample and/or for identifying dyes, which are inherently present or added by a colouring treatment, of the object or the sample, namely if the multicolour image is based, at least for the intensity pixels of at least one group of intensity pixels, on a respective superimposition of superimposition contributions allocated to various original colours in the sense of a type of additive or subtractive colour mixing, more specifically in particular in the case of at least approximately additive intensity contributions or intensity contents and/or at least approximately subtractive intensity contributions or intensity contents and colours and colour intensities resulting therefrom in the multicolour image, wherein it is ultimately unimportant how the multicolour image was produced, for example by a fluorescence microscopic examination or by a transmission microscopic or light-microscopic examination, for example with bright-field illumination, dark-field illumination or another relevant type of illumination.

In order to obtain at least qualitatively additional information from a multicolour image, a first aspect of the invention generally provides a method for generating a plurality of single-colour images from a multicolour image, defined by intensity pixels (I_{α}(x,y), I_{β}(x,y), I_{γ}(x,y)) of at least two colour channels (α, β, γ), of a sample or an object, for identifying properties or structures of the object or the sample and/or for identifying dyes, which are inherently present or added by a colouring treatment, of the object or the sample, the single-colour images being defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels, the multicolour image being based, at least for the intensity pixels of at least one group of intensity pixels, on a respective superimposition of superimposition contributions allocated to various original colours, in particular at least approximately additive intensity contributions or intensity contents and/or at least approximately subtractive intensity contributions or intensity contents. The invention proposes that the single-colour images represent superimposition contributions allocated to various original colours and be generated on the basis of characteristic intensity ratios which are assumed or predetermined or obtained from a calibration or derived from the multicolour image and represent ratios between at least two intensity contributions or intensity contents which are each allocated to another of the colour channels and are allocated to the same property or structure of the object or the sample or the same dye of the object or the sample.

It was assumed in this case that single-colour images were generated from multicolour images as a matter of course in the prior art, namely at least in the form of colour extracts for printing of the multicolour image by a colour printer. Colour extracts of this type normally do not provide any additional information over the multicolour image as represented, for example, on a screen.

According to a second, more specific aspect, the invention further provides a method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels, a) on a superimposition, taking place simultaneously, optionally in the detection, or successively, of at least two original colours which are each allocated or can at least approximately be allocated to at least one property or structure of the object or the sample and/or at least one dye, which is inherently present or added by a colouring treatment, of the object or the sample, the superimposition taking place in the sense of a subtractive colour mixing and/or based on an absorption and/or reflection and/or scattering, taking place during an illumination of the object or the sample with optical radiation, of various spectral contributions of optical radiation and then simultaneous and/or temporally successive detection of various spectral contributions, which have optionally been determined by a respective detection wavelength band and remained in the optical radiation after the absorption or reflection or scattering in transmission, of optical radiation and/or various spectral contributions, which have optionally been determined by a respective detection wavelength band and reflected or scattered by the object or the sample, of optical radiation, wherein the original colours are allocated or can be allocated to absorbed or detected contributions of optical radiation in the sense of an off-colour respectively allocated to the respective contribution of optical radiation or in the sense of a visual colour impression respectively resulting from a hypothetical or actual visual perception of the respective contribution of optical radiation, and b) on a pixel-by-pixel representation of mixed colours, resulting from the superimposition of the original colours, by the intensity pixels of the colour channels. The invention proposes that the method include the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions of an original colour for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels, the single-colour images being generated on the basis of characteristic intensity ratios which are assumed or predetermined or obtained from a calibration or derived from the multicolour image and represent ratios between at least two preferably additive or subtractive intensity contributions which are each allocated to another of the colour channels or intensity contents of the original colours corresponding to a pixel-by-pixel representation of the original colour by the intensity pixels or in the intensity pixels of the colour channels.

More specifically, a second aspect proposes, in particular, a method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels, a) on a superimposition, taking place simultaneously, optionally in the detection, or successively, of at least two colour channel-based original intensity values which are each allocated or can at least approximately be allocated to at least one property or structure of the object or the sample and/or at least one dye, which is inherently present or added by a colouring treatment, of the object or the sample, the superimposition taking place based on an absorption and/or reflection and/or scattering, taking place during an illumination of the object or the sample with optical radiation, of various spectral contributions of optical radiation and then simultaneous and/or temporally successive detection of various spectral contributions, which have optionally been determined by a respective detection wavelength band and remained in the optical radiation after the absorption or reflection or scattering in transmission, of optical radiation and/or various spectral contributions, which have optionally been determined by a respective detection wavelength band and reflected or scattered by the object or the sample, of optical radiation, wherein the original intensity values, which preferably enter into the superimposition at least approximately additively or subtractively, represent absorbed or detected contributions of optical radiation, and b) on a pixel-by-pixel representation of colour channel-based sequential intensity values, resulting from the superimposition of the original intensity values, by the intensity pixels of the colour channels. The invention provides that the method includes the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions by the original intensity values for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels, the single-colour images being generated on the basis of characteristic intensity ratios which are assumed or predetermined or obtained from a calibration or derived from the multicolour image and represent ratios between at least two original intensity values which are each allocated to another of the colour channels and are allocated to the same property or structure of the object or the sample or the same dye of the object or the sample.

According to a further, more specific, third aspect, the invention also provides a method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels, a′) on a superimposition, taking place simultaneously, optionally in the detection, or successively, of at least two original colours which are each allocated or can at least approximately be allocated to at least one property or structure of the object or the sample and/or at least one dye, which is inherently present or added by a colouring treatment, of the object or the sample, the superimposition taking place in the sense of an additive colour mixing of the original colours and/or based on an emission emanating from the object or the sample and then simultaneous and/or temporally successive detection of various spectral contributions, which have optionally been determined by a respective detection wavelength band, of optical radiation, wherein the original colours are allocated or can be allocated to detected contributions of optical radiation in the sense of an off-colour respectively allocated to the respective contribution of optical radiation or in the sense of a visual colour impression respectively resulting from a hypothetical or actual visual perception of the respective contribution of optical radiation, and b) on a pixel-by-pixel representation of mixed colours, resulting from the superimposition of the original colours, by the intensity pixels of the colour channels. The invention proposes that the method includes the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions of an original colour for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels, the single-colour images being generated on the basis of characteristic intensity ratios which are assumed or predetermined or obtained from a calibration or derived from the multicolour image and represent ratios between at least two preferably additive intensity contributions which are each allocated to another of the colour channels or intensity contents of the original colours corresponding to a pixel-by-pixel representation of the original colour by the intensity pixels or in the intensity pixels of the colour channels.

More specifically, according to the third aspect, there is proposed, in particular, a method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels, a′) on a superimposition, taking place simultaneously, optionally in the detection, or successively, of at least two colour channel-based original intensity values which are each allocated or can at least approximately be allocated to at least one property or structure of the object or the sample and/or at least one dye, which is inherently present or added by a colouring treatment, of the object or the sample, the superimposition taking place based on an emission emanating from the object or the sample and then simultaneous and/or temporally successive detection of various spectral contributions, which have optionally been determined by a respective detection wavelength band, of optical radiation, wherein the original intensity values, which preferably enter into the superimposition at least approximately additively, represent detected contributions of optical radiation, and b) on a pixel-by-pixel representation of colour channel-based sequential intensity values, resulting from the superimposition of the original intensity values, by the intensity pixels of the colour channels. The invention proposes that the method includes the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions by the original intensity values for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels, the single-colour images being generated on the basis of characteristic intensity ratios which are assumed or predetermined or obtained from a calibration or derived from the multicolour image and represent ratios between at least two original intensity values which are each allocated to another of the colour channels and are allocated to the same property or structure of the object or the sample or the same dye of the object or the sample.

The application of the invention considered in relation to the third aspect in fluorescence-based examinations, especially in fluorescence microscopy (specifically also wide-field fluorescence microscopy), usually has drawbacks compared to the prior art discussed at the outset, as the multicolour image on which the “unmixing” according to the invention is based would still have to be generated from the detected intensity images, which can be represented in false colours, for the fluorescence intensity detected in a locally resolved manner, wherein there would have to be taken into account, depending on the false colours selected, a resulting additional colour mixing which can lead to losses of information and increased unmixing costs. Nevertheless, the possibility of applying the invention to fluorescence-based multicolour image data of this type would not appear to be ruled out in specific examination operating sequences. Of greater interest, on the other hand, is likely to be the application of the invention to multicolour image data, which application entails to a certain extent superimposition contributions concealed in the colour based on a plurality of different superimposition mechanisms, for example a transmission microscopic or transmitted light-microscopic examination, for example a bright-field microscopic examination or another transmission microscopic or light-microscopic examination with any type of illumination, with additional fluorescence radiation contributions based on a simultaneous excitation of fluorophores emitting in the visible wavelength range. It is therefore proposed, developing the first aspect of the invention, that the multicolour image also respectively be based, at least for the intensity pixels of at least a partial group of the at least one group of intensity pixels, a′) on a superimposition, taking place simultaneously, optionally in the detection, or successively, of at least two original colours which are each allocated or can at least approximately be allocated to at least one property or structure of the object or the sample and/or at least one dye, which is inherently present or added by a colouring treatment, of the object or the sample, the superimposition taking place in the sense of an additive colour mixing of the original colours and/or based on an emission emanating from the object or the sample and then simultaneous and/or temporally successive detection of various spectral contributions, which have optionally been determined by a respective detection wavelength band, of optical radiation, wherein the original colours are allocated or can be allocated to detected contributions of optical radiation in the sense of an off-colour respectively allocated to the respective contribution of optical radiation or in the sense of a visual colour impression respectively resulting from a hypothetical or actual visual perception of the respective contribution of optical radiation.

More specifically, a development of the invention proposes, in particular, that the multicolour image also respectively be based, at least for the intensity pixels of at least a partial group of the at least one group of intensity pixels, a′) on a superimposition, taking place simultaneously, optionally in the detection, or successively, of at least two colour channel-based original intensity values which are each allocated or can at least approximately be allocated to at least one property or structure of the object or the sample and/or at least one dye, which is inherently present or added by a colouring treatment, of the object or the sample, the superimposition taking place based on an emission emanating from the object or the sample and then simultaneous and/or temporally successive detection of various spectral contributions, which have optionally been determined by a respective detection wavelength band, of optical radiation, wherein the original intensity values represent detected contributions of optical radiation.

It is intended, above all, that a respective superimposition contribution is to be understood as an intensity content or intensity contribution for a respective colour channel, which intensity content or intensity contribution can be traced back, using a linear, subtractive or additive approach in the superimposition, to a respective property or structure or a respective dye of the object or the sample. In particular, it is intended that a respective superimposition contribution is to be understood, using a linear, subtractive approach, as an intensity content, removed from the optical radiation in transmission by absorption resulting from a respective property or by a respective structure or a respective dye of the object or the sample, for a respective colour channel.

It is also possible that a respective superimposition contribution is to be understood, using a linear, additive approach, as an additive intensity contribution, emanating as a result of a respective property of the object or the sample or of a respective structure or a respective dye of the object or the sample, for a respective colour channel. In this context, it is intended, specifically, that a respective superimposition contribution is to be understood as an additive intensity contribution resulting from a stimulation of a dye and emission, resulting therefrom, of optical radiation by the dye for the respective colour channel.

Provision may be made for a plurality of single-colour images, each representing the superimposition contributions of the original colour for another of the colour channels, to be generated for each original colour and/or for there to be generated for each original colour a single-colour image which represents overall superimposition contributions of the original colour to the colour channels and corresponds to a pixel-by-pixel combination of the intensity pixels of the single-colour images respectively representing the superimposition contributions of the original colour for the colour channels, in particular a pixel-by-pixel combination containing a summation of the intensity values of the intensity pixels of the single-colour images respectively representing the superimposition contribution of the original colour for the colour channels. More specifically, provision may be made, in particular, for a plurality of single-colour images, each representing the superimposition contributions by the original intensity values for another of the colour channels, to be generated based on a respective property or structure of the object or the sample or on a respective dye of the object or the sample and/or for there to be generated, based on a respective property or structure of the object or the sample or on a respective dye of the object or the sample, a single-colour image which represents overall superimposition contributions to the colour channels and corresponds to a pixel-by-pixel combination of the intensity pixels of the single-colour images respectively representing the superimposition contributions by the original intensity values, in particular a pixel-by-pixel combination containing a summation of original intensity values for the colour channels.

The multicolour image of the object or the sample will generally be defined by intensity pixels (I_{α}(x,y), I_{β}(x,y), I_{γ}(x,y)) of at least three colour channels (α, β, γ), above all by intensity pixels of precisely three colour channels. The colour channels may be conventional channels such as those used for a computer-assisted representation on an electronic screen.

It is intended, inter alia, that the optical radiation be detected simultaneously or in temporal succession in at least two, preferably at least three different detection wavelength bands, which are spectrally offset from one another or if appropriate spectrally overlap, of a detector assembly. Provision may be made in this regard for the detection wavelength bands each to be allocated to one of a plurality of detection colour channels of the detector assembly which is configured as a colour image detector assembly, wherein the detection colour channels are allocated to various primary colours which correspond to the detection wavelength bands and from which, in accordance with an intensity value which is detected pixel-by-pixel for the respective detection colour channel, a colour, which is detected for the respective pixel or a group of pixels each allocated to one of the colour channels, can be additively mixed. A development of the invention proposes that the colour channels of the detector assembly correspond to the colour channels on the basis of which the multicolour image is defined, so the detector assembly directly prepares the multicolour image or prepares at least one intermediate multicolour image from which the multicolour image is generated without being converted to a colour illustration based on other primary colours. Alternatively, provision may be made for the colour channels of the detector assembly to differ from the colour channels on the basis of which the multicolour image is defined, so the detector assembly prepares at least one intermediate multicolour image from which the multicolour image is generated while being converted to a colour illustration based on the representation of the superimposition, in particular the representation of the primary colours on which mixed colours or sequential intensity values are based.

It is intended, inter alia, that the superimposition include a simultaneous emission of a plurality of different spectral contributions of optical radiation and then a simultaneous detection of these contributions. However, it is entirely conceivable for the superimposition to include an emission in temporal succession of various spectral contributions of optical radiation and then accordingly a detection in temporal succession of these contributions and then a pixel-by-pixel superimposition of a plurality of intermediate single-colour images or intermediate multicolour images, each obtained from the detection, to form the multicolour image. Provision may be made in this regard for at least one of the intermediate single-colour images or intermediate multicolour images itself to be based on a superimposition including a simultaneous emission of a plurality of different spectral contributions of optical radiation and then a simultaneous detection of these contributions.

As indicated hereinbefore, the above-discussed emission of the spectral contributions of optical radiation can be based on an optical excitation by optical excitation radiation. It is possible in this regard for the emission of the spectral contributions to be based on an optical excitation by various spectral contributions, which may be determined by a respective excitation wavelength band, of optical excitation radiation. It is generally intended in this connection for various detection wavelength bands and/or various excitation wavelength bands to be allocated to various properties or structures of the object or the sample or various dyes, in particular fluorochromes, of the object or the sample. Specifically, provision may expediently be made for various detection wavelength bands and the same excitation wavelength bands or the same detection wavelength bands and various excitation wavelength bands to be allocated to various properties or structures of the object or the sample or various dyes, in particular fluorochromes, of the object or the sample.

In relation to a specific application of the invention, it is intended, above all, that the superimposition include a simultaneous or successive detection of various spectral contributions of optical radiation based on the same illumination of the object or the sample with optical radiation, especially an examination of the object or the sample in transmission (transmitted light). Transmission microscopic, for example bright-field transmission microscopic or dark-field transmission microscopic, applications are, in particular, possible.

A development of the invention proposes that the superimposition include a simultaneous or successive detection of various spectral contributions of optical radiation based on the same illumination of the object or the sample with multispectral, preferably broadband optical radiation, most preferably white light. Colour information resulting in the multicolour image is then based, above all, on spectrally selective absorption, for example by dyes which are inherently present or are introduced by a colouring treatment.

It is generally intended that mutually allocated individual spectral partial contributions of each contribution of the optical radiation or spectral superimposition partial contributions which result from a superimposition of a plurality of spectral contributions and correspond to a superimposition of respective spectral partial contributions of the spectral contributions, superimposed one on top of another, of optical radiation be detected pixel-by-pixel within the detection wavelength bands of the detector assembly for the spectral contributions of optical radiation. It is also intended in this connection that, in accordance with an intensity value which is detected pixel-by-pixel for the respective detection colour channel, a colour, which is detected for the respective pixel or a group of pixels each allocated to one of the colour channels, in particular an original colour or a colour complementary to the original colour, can be additively mixed from the partial contributions or that, in accordance with an intensity value which is detected pixel-by-pixel for the respective detection colour channel, a colour, which is detected for the respective pixel or a group of pixels each allocated to one of the colour channels, in particular a mixed colour resulting from the superimposition of original colours or of colours complementary thereto, can be additively mixed from the superimposition contributions.

An especially expedient embodiment of the various aspects of the invention provides for the generation of the single-colour images, representing the superimposition contributions, for each pixel of the group or partial group to include mathematical operations which include the solution to a system of linear equations comprising a plurality of unknown quantities by methods of linear algebra or ratio methods or correspond mathematically to the exact or approximate solution to a system of equations of this type. It is intended in this regard, above all, that the number of linear equations per pixel correspond at most to the number of colour channels. There can then normally be generated three mutually independent single-colour images which each show a colour mixing contribution or a mixing contribution in terms of intensity and show, for example, the mixing contributions of three different colours or colourings of the object or the sample. The mathematical operations include, in this case, the solution to a system of three linear equations comprising three unknown quantities by methods of linear algebra or ratio methods or correspond mathematically to the exact or approximate solution to a system of equations of this type.

It is intended in this connection, specifically (but not exclusively) with reference to the third aspect of the invention, that the generation of the single-colour images be based on a system of equations, of which the equations for three colour channels generally have the following form or can be brought into the following form:

I_{α}(x,y)=I_{α}(x,y,f1)+I_{α}(x,y,f2)+I_{α}(x,y,f3)

I_{β}(x,y)=I_{β}(x,y,f1)+I_{β}(x,y,f2)+I_{β}(x,y,f3)

I_{γ}(x,y)=I_{γ}(x,y,f1)+I_{γ}(x,y,f2)+I_{γ}(x,y,f3)

wherein I_{α}(x,y), I_{β}(x,y), I_{γ}(x,y) are the intensity values of the intensity pixels of the multicolour image for the three colour channels α, β and γ, the coordinates x,y identify a respective pixel and the terms to the right of the equals signs each specify an additive superimposition contribution to the intensity value of the respective colour channel α or β or γ resulting from a property or structure or a dye f1 or f2 or f3 of the sample or the object.

It is also intended in this connection, specifically (but not exclusively) with reference to the second aspect of the invention, that the generation of the single-colour images be based on a system of equations, of which the equations for three colour channels generally have the following form or can be brought into the following form:

I_{α}(x,y)=I_{α}^{MAX}−I_{α}(x,y,f1)−I_{α}(x,y,f2)−I_{α}(x,y,f3)

I_{β}(x,y)=I_{β}^{MAX}−I_{β}(x,y,f1)−I_{β}(x,y,f2)−I_{β}(x,y,f3)

I_{γ}(x,y)=I_{γ}^{MAX}−I_{γ}(x,y,f1)−I_{γ}(x,y,f2)−I_{γ}(x,y,f3)

wherein I_{α}(x,y), I_{β}(x,y), I_{γ}(x,y) are the intensity values of the intensity pixels of the multicolour image for the three colour channels α, β and γ, the coordinates x,y identify a respective pixel, the terms I_{α}^{MAX}, I_{β}^{MAX}, I_{γ}^{MAX} specify an intensity value, which is the maximum possible value for a given examining situation, for the respective colour channel α or β or γ and the remaining terms to the right of the equals signs each specify a subtractive superimposition contribution to the intensity value of the respective colour channel α or β or γ resulting from a property or structure or a dye f1 or f2 or f3 of the sample or the object. It is intended that the terms I_{α}^{MAX}, I_{β}^{MAX}, I_{γ}^{MAX}, which specify a maximum possible intensity value for the colour channels α, β and γ, be predetermined. It is, however, particularly advantageously intended that these terms be determined from the multicolour image, preferably by determining a maximum pixel intensity for the respective colour channel from all intensity pixels.

A particularly preferred implementation of the spectral or colour unmixing provides for the respective system of equations for the terms I_{α}(x,y,f1), I_{β}(x,y,f1), I_{γ}(x,y,f1) and/or for the terms I_{α}(x,y,f2), I_{β}(x,y,f2), I_{γ}(x,y,f2) and/or for the terms I_{α}(x,y,f3), I_{β}(x,y,f3), I_{γ}(x,y,f3) to be solved on the basis of characteristic intensity ratios

R_{αβ}(f1)=I_{α}(f1)/I_{β}(f1)

R_{αγ}(f1)=I_{α}(f1)/I_{γ}(f1)

R_{αβ}(f2)=I_{α}(f2)/I_{β}(f2)

R_{αγ}(f2)=I_{α}(f2)/I_{γ}(f2)

R_{αβ}(f3)=I_{α}(f3)/I_{β}(f3)

R_{αγ}(f3)=I_{α}(f3)/I_{γ}(f3)

or characteristic intensity ratios which can be derived therefrom and specify the ratio between two superimposition contributions Iₐ( ) I_{b}( ), contributing additively or subtractively to differing colour channels a, b, resulting from the same property or structure or the same dye f1 or f2 or f3 of the sample or the object, a, b each referring to two different channels of the colour channels α, β, γ.

Provision may advantageously be made in this regard for the characteristic intensity ratios to be determined from the multicolour image, preferably on the basis of an identification of image regions which are based, without superimposition of a plurality of additive or subtractive superimposition contributions for each colour channel, merely on additive or subtractive intensity contributions I_{α}(x,y,f1), I_{β}(x,y,f1), I_{γ}(x,y,f1) or I_{α}(x,y,f2), I_{β}(x,y,f2), I_{γ}(x,y,f2) or I_{α}(x,y,f3), I_{β}(x,y,f3), I_{γ}(x,y,f3) resulting from precisely one property or structure or precisely one dye f1 or f2 or f3 of the sample or the object. Separate calibration or reference measurements may then be dispensed with. However, this will not always be possible. It is therefore proposed as an alternative that the characteristic intensity ratios be determined from calibration multicolour images generated for calibration samples or calibration objects, the calibration samples or calibration objects being chosen or prepared in such a way that they are based, at least in an image region of the calibration multicolour image without superimposition of a plurality of additive or subtractive superimposition contributions for each colour channel, merely on additive or subtractive intensity contributions I_{α}(x,y,f1), I_{β}(x,y,f1), I_{γ}(x,y,f1) or I_{α}(x,y,f2), I_{β}(x,y,f2), I_{γ}(x,y,f2) or I_{α}(x,y,f3), I_{β}(x,y,f3), I_{γ}(x,y,f3) resulting from precisely one property or structure or precisely one dye f1 or f2 or f3 of the calibration sample which is thus representative of the sample or the calibration object which is thus representative of the object.

According to a fourth aspect related to the second aspect of the invention, the invention further provides a method for examining objects or samples, wherein, of an object or a sample in transmission for a plurality of different detection wavelength bands which are spectrally offset from one another, a respective image, indicating in intensity values detected in a locally resolved manner a weakening of optical radiation passing through the object or the sample in the respective detection wavelength band resulting from absorption, of the object or the sample is recorded and wherein there are generated, on the basis of characteristic intensity ratios which are assumed or predetermined or obtained from a calibration or derived from a plurality of the images, images which result from the images and represent the absorption contents based on various properties and/or structures, absorbing the optical radiation, of the object or the sample and/or based on various dyes, absorbing the optical radiation, of the object or the sample.

The proposed method is generalised compared to the method according to the second aspect insofar as reference is generally made to detection wavelength bands which do not necessarily have to correspond to colour channels of an image representation. Insofar as the linear, subtractive approach, discussed hereinbefore in relation to the second aspect of the invention, holds at least approximately for the images recorded in transmission with regard to the absorption contents based on various properties or structures or dyes of the object or the sample, quantitative or at least qualitative information about the respective absorption contents can be extracted from the recorded images in that the recorded images are to a certain extent unmixed in order to generate the resulting images.

It is conceivable that various detection wavelength bands may not be distinguished from one another in terms of colour sufficiently clearly to allow them to be understood as differing colour channels. Otherwise, the foregoing remarks concerning the second aspect of the invention relating to subtractive superimposition contributions (subtractive intensity contents or intensity contributions in a linear subtractive approach) apply accordingly. It is therefore intended, in particular, that the generation of the resulting images includes mathematical operations which include the solution to a system of linear equations comprising a plurality of unknown quantities by methods of linear algebra or ratio methods or correspond mathematically to the exact or approximate solution to a system of equations of this type. Compared to the case of three colour channels, a generalised development of the invention therefore proposes that the generation of the resulting images be based on a system of equations, of which the equations for N detection wavelength bands D1 to DN generally have the following form or can be brought into the following form:

I_{D1}(x,y)=I_{D1}^{MAX}−I_{D1}(x,y,f1)−I_{D1}(x,y,f2)− . . . −I_{D1}(x,y,fN)

I_{D2}(x,y)=I_{D2}^{MAX}−I_{D2}(x,y,f1)−I_{D2}(x,y,f2)− . . . −I_{D1}(x,y,fN)

. . .

I_{DN}(x,y)=I_{DN}^{MAX}−I_{DN}(x,y,f1)−I_{DN}(x,y,f2)− . . . −I_{DN}(x,y,fN)

wherein I_{D1}(x,y), . . . , I_{DN}(x,y) are the intensity values, detected in a locally resolved manner, of each of the recorded images, x,y are location coordinates or identify a respective pixel of the recorded image, the terms I_{D1}^{MAX}, . . . , I_{DN}^{MAX} specify an intensity value, which is the maximum possible value for a given examining situation, for the respective detection wavelength band D1 to DN and the remaining terms to the right of the equals signs each specify a subtractive superimposition contribution to the intensity value of the respective recorded image resulting from a property or structure or a dye of various dyes f1 to fN of the sample or the object. More than three different dyes may, if appropriate, be separated on the basis of more than three images recorded in various detection wavelength bands.

It is, in particular, intended that the terms I_{D1}^{MAX}, . . . , I_{DN}^{MAX}, specifying a maximum possible intensity value for the detection wavelength bands D1 to DN, be determined from the respective recorded image, preferably by determining a maximum intensity. The system of equations is preferably solved on the basis of characteristic intensity ratios

R_{DID2}(f1)=I_{D1}(f1)/I_{D2}(f1)

. . .

R_{DIDN}(f1)=I_{D1}(f1)/I_{DN}(f1)

R_{DID2}(f2)=I_{D1}(f2)/I_{D2}(f2)

. . .

R_{DIDN}(f2)=I_{D1}(f2)/I_{DN}(f2)

. . .

R_{DID2}(fN)=I_{D1}(fN)/I_{D2}(fN)

. . .

R_{DIDN}(fN)=I_{D1}(fN)/I_{DN}(fN)

or characteristic intensity ratios which can be derived therefrom and specify the ratio between two absorption contents, contributing subtractively to various detection wavelength bands, resulting from the same property or structure or the same dye of the sample or the object.

It is proposed in this connection that the characteristic intensity ratios each be determined from two of the recorded images, preferably on the basis of an identification of image regions based merely on absorption contents resulting from precisely one property or structure or precisely one dye of the sample or the object. If this is not possible or expedient, the characteristic intensity ratios can be determined from calibration images recorded for calibration samples or calibration objects, wherein the calibration samples or calibration objects are selected or prepared so as to be based, at least in an image region of the calibration image, merely on absorption contents resulting from precisely one property or structure or precisely one dye of the calibration sample which is thus representative of the sample or the calibration object which is thus representative of the object.

It will be clear from the foregoing remarks, especially in relation to the discussion of the second aspect of the invention, that the fourth aspect of the invention can be implemented specifically as a method corresponding to the second aspect of the invention. This is true, in particular, if the detection wavelength bands correspond to colour channels of a detector assembly or if images of the detection wavelength bands can be clearly formed on colour channels of a multicolour image representation, for example as a superimposed false colour representation of the recorded images. The generation of the resulting images can correspondingly be implemented in accordance with the first aspect of the invention. The foregoing description of relevant possible embodiments and developments of the first or second aspect of the invention may accordingly also be applied to the fourth aspect of the invention.

With regard to the method according to the invention for examining objects or samples, it is intended, above all, that the optical radiation be detected in a locally resolved manner using a microscope. The multicolour image may accordingly be a microscopic photograph or be based on at least one microscopic photograph. It is intended, in particular, that the multicolour image is a microscopic transmission multicolour image or bright-field multicolour image or dark-field multicolour image of the object or the sample or is based on at least one microscopic transmission multicolour image or bright-field multicolour image or dark-field multicolour image of the object or the sample or a plurality of microscopic transmission images or bright-field images or dark-field images, optionally single-colour or black-and-white images, of the object or the sample. In the case of the fourth aspect of the invention, the recorded images may be microscopic transmission images or bright-field images or dark-field images of the object or the sample. In principle, there are no restrictions on the method of illumination in transmission microscopic or light-microscopic examinations or images resulting therefrom; the “bright-field” and “dark-field” methods referred to are merely examples.

The sample or samples or the object is intended, above all, to be a biological sample or biological samples or a biological object. Examples include a histological cutting in the case of which the invention may be used especially expediently for the extraction of information.

As mentioned hereinbefore, the methods according to the invention for examining objects or samples can include the step of colouring at least one structure of the sample or the object with at least one dye. It is also intended that the dyes of the sample be inherently present dyes, for example naturally present dyes or dyes resulting on the basis of genetic engineering.

It will generally be expedient if the colour channels or detection wavelength bands correspond to colour channels for representing the multicolour image or the recorded images on an electronic screen, for example RGB colour channels.

A fifth aspect of the invention also provides an arrangement for carrying out the method according to the invention in accordance with the various aspects of the invention, including the various developments of the method. The arrangement according to the invention comprises: an image memory for storing a multicolour image, defined by intensity pixels (I_{α}(x,y), I_{β}(x,y), I_{γ}(x,y)) of at least two colour channels (α, β, γ), of a sample or an object, the multicolour image being respectively based, at least for the intensity pixels of at least one group of intensity pixels, on a superimposition of superimposition contributions allocated to various original colours, in particular at least approximately additive intensity contributions or intensity contents and/or at least approximately subtractive intensity contributions or intensity contents, an image processing unit which operates on the intensity pixels of the multicolour image and breaks the multicolour image down into single-colour images which it stores in the image memory, the single-colour image being defined by intensity pixels of only one of the colour channels or by intensity pixels of a plurality of the colour channels having an intensity ratio, which is the same for all intensity pixels, between the colour channels or by intensity pixels of only one resulting colour channel corresponding to a defined combination of the colour channels. The invention proposes that the image processing unit be configured or programmed to generate the single-colour images, which represent superimposition contributions allocated to various original colours, on the basis of characteristic intensity ratios which are assumed or predetermined or obtained from a calibration or derived from the multicolour image and represent ratios between at least two intensity contributions or intensity contents which are each allocated to another of the colour channels and are allocated to the same property or structure of the object or the sample or the same dye of the object or the sample.

The arrangement according to the invention may also comprise means for generating the multicolour image, for example a microscope and a local resolution detector assembly.

The invention also provides a computer program product, for example in the form of a program which can be stored on a data carrier or downloaded from a server, for example via the Internet, which program can be executed by a computer and carries out during execution of the program by a processor means of the computer, on the basis of a multicolour image stored in a storage means of the computer, the method according to the first aspect or the generation of the single-colour images from the multicolour image in the methods according to the second and third aspect of the invention, preferably including the various developments, relating to the generation of the single-colour images, of the method according to the invention in accordance with the various aspects of the invention.

The invention will be described hereinafter in greater detail with reference to embodiments shown in the figures and a method (“unmixing method”) which is given by way of example and is also to be understood as an embodiment. In the drawings:

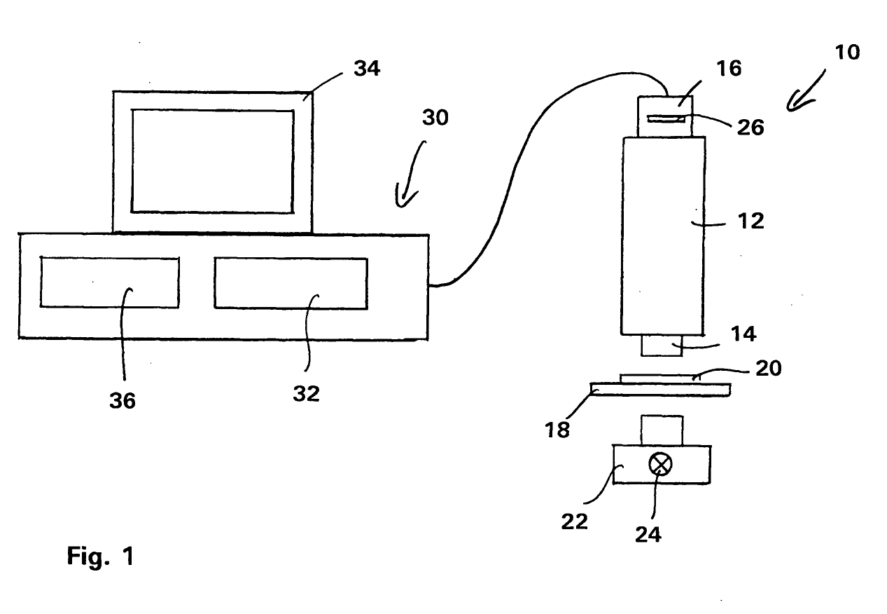

FIG. 1 shows an example of an object and sample examining arrangement according to the invention based on a transmission microscope and a computing unit evaluating image data from a colour camera of the microscope and “unmixing” the image data, for example in the form of a correspondingly programmed computer;

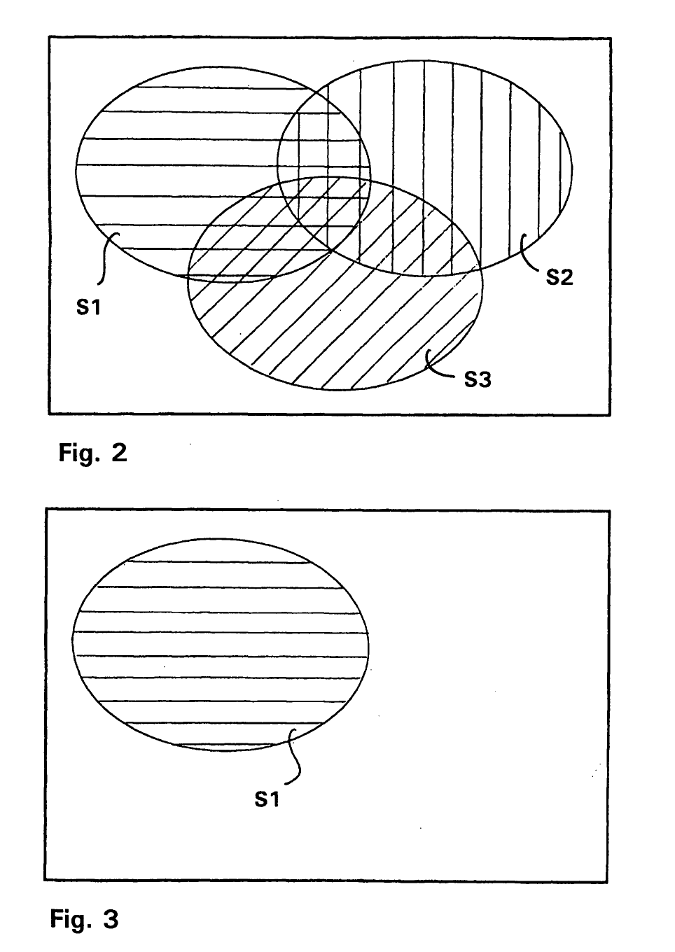

FIG. 2 shows schematically an example of a multicolour image, recorded using the colour camera of the microscope, of an object comprising three different-coloured structures which overlap in certain regions, the multicolour image being represented by intensity pixels of three colour channels;

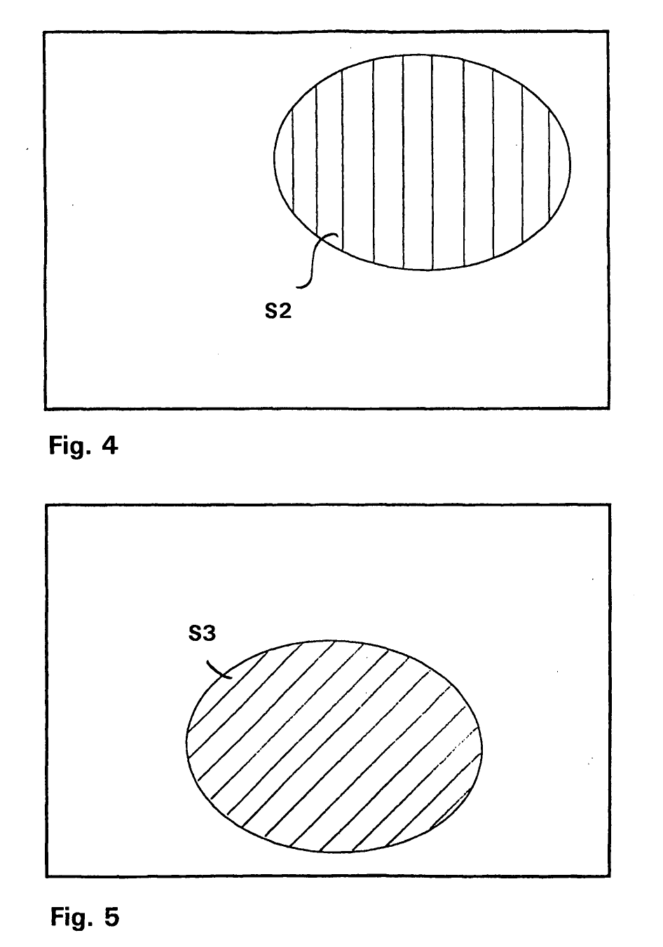

FIG. 3 shows schematically a single-colour image which was obtained by unmixing the colour information of the multicolour image according to FIG. 2 and shows a first of the three structures;

FIG. 4 shows schematically a further single-colour image which was obtained by unmixing the colour information of the multicolour image according to FIG. 2 and shows a second of the three structures;

FIG. 5 shows schematically a further single-colour image which was obtained by unmixing the colour information of the multicolour image according to FIG. 2 and shows a third of the three structures;

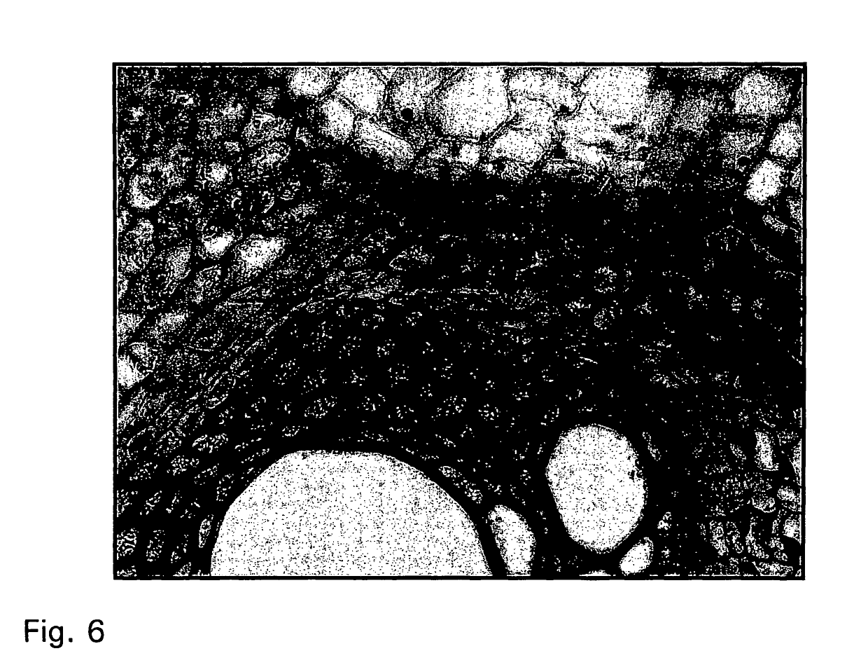

FIG. 6 is a black-and-white/greyscale representation of a multicoloured transmission microscopic photograph of a dyed clematis cutting;

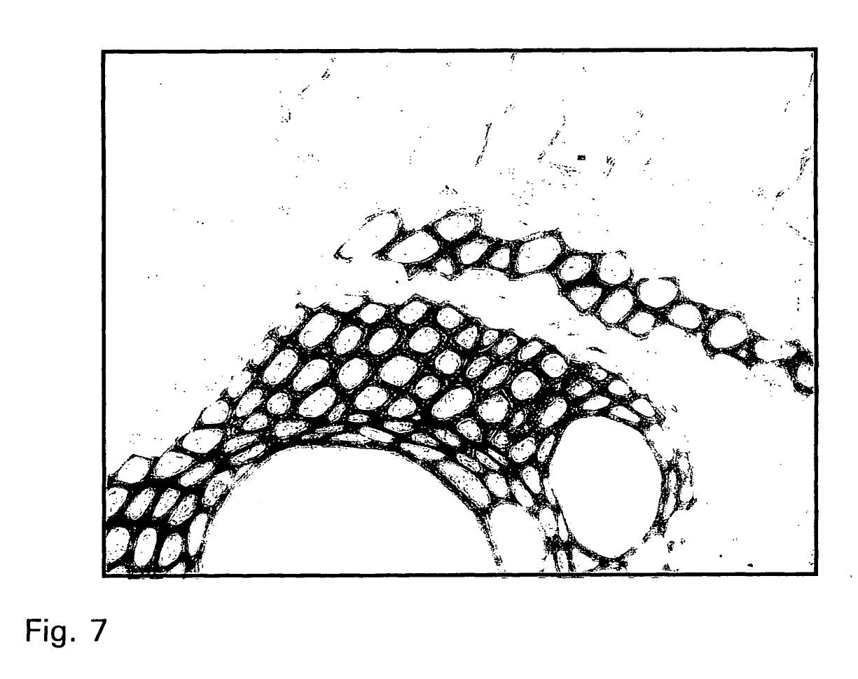

FIG. 7 is a black-and-white/greyscale representation of a single-colour image which was obtained from the multicolour image according to FIG. 6 by colour unmixing and shows the absorption contributions based on a first dye of the clematis cutting;

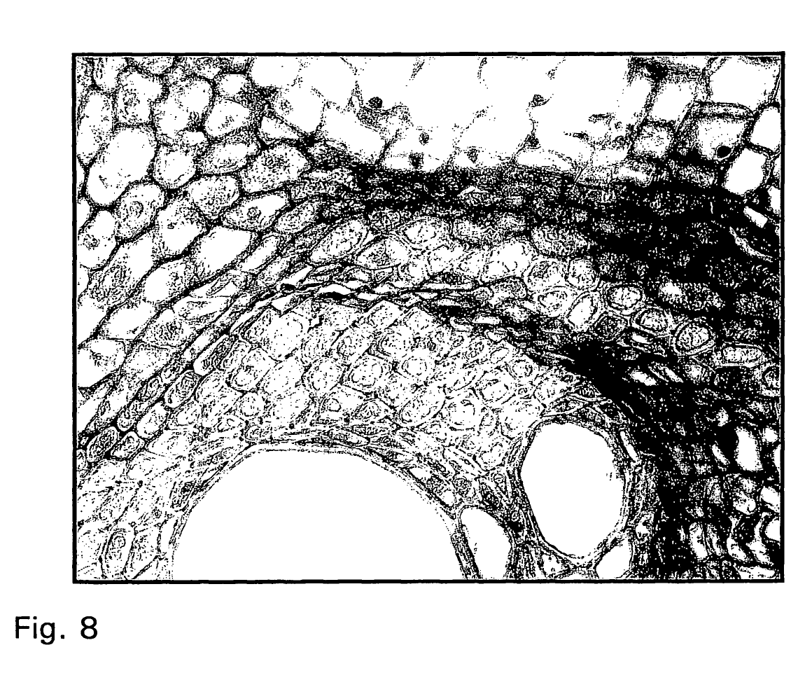

FIG. 8 is a black-and-white/greyscale representation of a further single-colour image which was obtained from the multicolour image according to FIG. 6 by colour unmixing and shows the absorption contributions based on a second dye of the clematis cutting; and

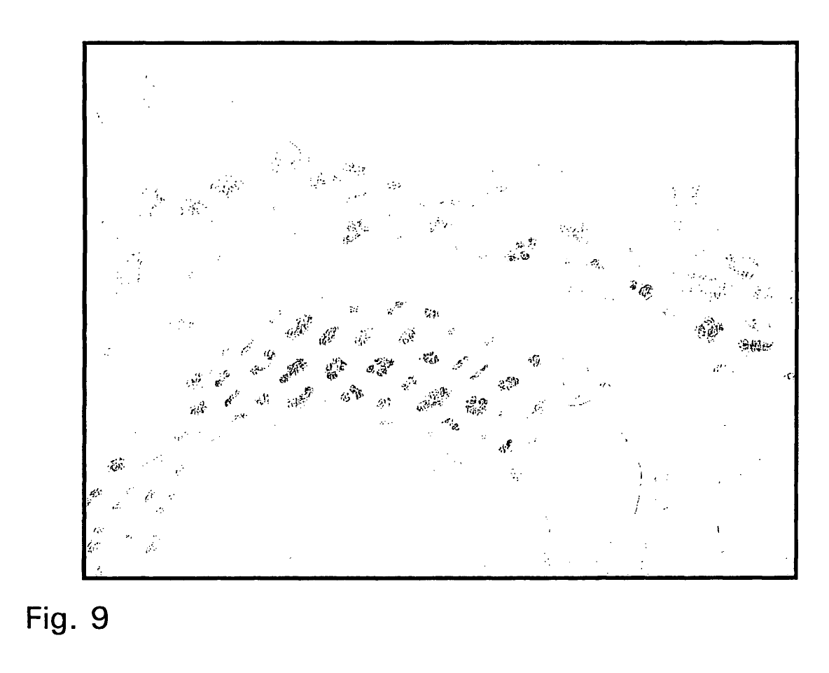

FIG. 9 is a black-and-white/greyscale representation of a further single-colour image which was obtained from the multicolour image according to FIG. 6 by colour unmixing and shows the absorption contributions based on a third dye of the clematis cutting.

FIG. 1 shows an example of an arrangement 10 for transmission microscopic examinations of samples or objects, in particular biological samples such as cuttings which are dyed or have their natural colour. An optical transmission microscope 12 with a microscope lens 14 on the side of the sample and a CCD colour camera 16 on the side of the image is used to examine samples arranged on a sample stage 18, for example on an object carrier 20, in that the microscope forms a magnified image of the object on at least one detector field 26 of the camera on the basis of optical radiation which is provided by a transmitted-light illumination unit 22 and passes through the object, in particular white light from a white light source 24. The magnified microscopic image is detected pixel-by-pixel in a locally resolved manner in three colour channels of the camera. A multicolour image thus recorded, comprising intensity pixels of three colour channels, is recorded by a computer 30 associated with the arrangement 10 and stored in a storage unit 32 of the computer. The multicolour image can be displayed on a screen 34. A processor unit 36 of the computer is used to further process the recorded multicolour image. According to the invention, the processing unit 36 generates, on the basis of the multicolour image stored in the storage unit 32 or on the basis of the multicolour image receiving directly from the colour camera, three single-colour images representing colour mixing contributions based on three different colourings or dyes of the sample. The scope of the unmixing of the multicolour image to form three single-colour images is possible quantitatively, but in any case at least qualitatively, as a subtractive linear approach has some approximate validity for the colours resulting in the multicolour image on the basis of the colourings of the sample.

### Embodiment and Variations of a Computing Method for Colour or Spectral Unmixing of Multicolour Images

A method for separating objects of various colours into, for example, microscopic transmission images will be described hereinafter by way of example.

### Formation of Transmission Colour Images

Multispectral, in particular white light is shone through the object which is multicoloured from the outset or after a colouring treatment. The colours, which are perceivable to the eye or a colour camera, for example a CCD camera, are formed by selective absorption in the object. If, for example, red (approx. 600 to 650 nm) is absorbed by the object, the object appears green (mixture of 400 to 600 nm).

### Detection of Each Transmission Colour Image:

Simultaneous detection with a digital camera having three colour channels, in particular an RGB camera with the colour channels R (red), G (green) and B (blue), is assumed without loss of generality. A camera of this type is conventionally configured as a CCD camera and has at least one CCD detector field, so a rectangular field of pixels is obtained for each colour channel. For example, there is provided a single detector field which is common to the colour channels and is covered by a filter region for the mosaic colour filters having three colour channels in order to allocate the detection pixels to one of the colour channels and to allow there to fall on the respective detection pixel only light within each detection wavelength band corresponding to the colour channel. Generally, the detection wavelength bands overlap to a high degree, so an object which to the human eye appears “only” red leads to a signal, albeit in some cases only a low signal, also in the green channel. The same applies to the other channels and to the colours green and blue. Detected mixed colours, in particular, provide substantial contributions in a plurality of the colour channels. The mixed colour yellow, for example, thus contains high contents of green and red.

In order to allow a colour detection which is equivalent to human perception, it is often possible to carry out “white balancing” in a computer-assisted measuring station or a computer used for the processing of recorded images. In this case, a software package determines a “white” region (automatic white balance) in the image or the user defines a region in the image as “white”. The images recorded with the camera and images represented on a monitor of an object then ideally appear as they do when perceived by the human eye.

### Colour Unmixing of Transmission Multicolour Images for Three Dyes or Three Colour Channels

The preparation dyed with three dyes (optionally three fluorochromes) f1, f2 and f3 is detected in three different wavelength ranges α, β, and γ corresponding to three colour channels α, β and γ of a pixel-by-pixel representation of a resulting multicolour image. The dyes have accumulated, for example, on three different structures S1, S2 and S3 of the preparation. It can be assumed without loss of generality that the three colour channels are RGB colour channels, for example α=R (red), β=(green) and γ=B (blue).

The absorption of light by matter is described mathematically by the Lambert-Beer law:

I=I₀*e^{-β}*^{x}

wherein β describes the coefficient of absorption and x the penetration depth. The series expansion of the e-function up to the first term produces a linear relationship between the absorption and concentration or layer thickness of the dyes provided and therefore of the intensity detected pixel-by-pixel for three colour channels α, β and γ allocated to the wavelength ranges α, β and γ:

I_{α}=illumination_{α}−I_{α}(f₁)−I_{α}(f₂)−I_{α}(f₃)

I_{β}=illumination_{β}−I_{β}(f₁)−I_{β}(f₂)−I_{β}(f₃)

I_{γ}=illumination_{γ}−I_{γ}(f₁)−I_{γ}(f₂)−I_{γ}(f₃)

Illumination_{α}=I_{α}^{MAX}; illumination_{β}=I_{β}^{MAX}; illumination_{γ}=I_{γ}^{MAX}: (Equations 1)

is the illuminance in the wavelength range α or β or γ or—more specifically—the intensity value which is the maximum possible value in a given situation for the colour channel α or β or γ corresponding to the wavelength range can be approximated by forming the maximum via the image. This presupposes that, for at least one pixel, no absorption, or at least only negligible absorption, occurs in the corresponding wavelength range.

I_{α}(f₁); I_{β}(f₁); I_{γ}(f₁):

is a measure of absorption (and thus of the concentration/layer thickness of the dye f1) in the wavelength range α or β or γ caused by the dye f1 or by the structure S1 which, based on the colouring treatment, comprises the dye f1 (alternatively, f1 could be a dye inherently present in the preparation).

I_{α}(f₂); I_{β}(f₂); I_{γ}(f₂):

is a measure of absorption (and thus of the concentration/layer thickness of the dye f2) in the wavelength range α or β or γ caused by the dye f2 or by the structure S2 which, based on the colouring treatment, comprises the dye f2 (alternatively, f2 could be a dye inherently present in the preparation).

I_{α}(f₃); I_{β}(f₃); I_{γ}(f₃):

is a measure of absorption (and thus of the concentration/layer thickness of the dye f3) in the wavelength range α or β or γ caused by the dye f3 or by the structure S3 which, based on the colouring treatment, comprises the dye f3 (alternatively, f3 could be a dye inherently present in the preparation).

The relevant information then lies not in the directly measurable sum of the intensity contents, which originate from the various fluorochromes or dyes, specify the degree of absorption and to a certain extent enter subtractively into the intensities detected for the colour channels, in a wavelength range but rather in the individual subtractive intensity contents for each dye or in the sum of the subtractive intensity contents resulting from each dye f1, f2 or f3 (or each structure S1, S2 or S3):

I_{f1}=I_{α}(f₁)+I_{β}(f₁)+I_{γ}(f₁)

I_{f2}=I_{α}(f₂)+I_{β}(f₂)+I_{γ}(f₂)

I_{f3}=I_{α}(f₃)+I_{β}(f₃)+I_{γ}(f₃)

It is assumed that the following six ratio values are known. These ratio values can in any case be determined using calibration samples or else from the recorded multicolour image itself.

R_{αβ}(f₁)=I_{α}(f₁)/I_{β}(f₁)

R_{αγ}(f₁)=I_{α}(f₁)/I_{γ}(f₁)

R_{αβ}(f₂)=I_{α}(f₂)/I_{β}(f₂)

R_{αγ}(f₂)=I_{α}(f₂)/I_{γ}(f₂)

R_{αβ}(f₃)=I_{α}(f₃)/I_{β}(f₃)

R_{αγ}(f₃)=I_{α}(f₃)/I_{γ}(f₃)

Equations 1 can therefore be written as follows:

I_{α}=illumination_{α}−I_{α}(f₁)−I_{α}(f₂)−I_{α}(f₃)

I_{β}=illumination_{β}−I_{α}(f₁)/R_{αβ}(f₁)−I_{α}(f₂)/R_{αβ}(f₂)−I_{α}(f₃)/R_{αβ}(f₃)

I_{γ}=illumination_{γ}−I_{α}(f₁)/R_{αγ}(f₁)−I_{α}(f₂)/R_{αγ}(f₂)−I_{α}(f₃)/R_{αγ}(f₃)

In matrix notation, this reads as follows:

$${I}^{->} - {illumination}^{->} = M α * {I α}^{->}$$

$$wherein \text{:} {I}^{->} = ( \begin{matrix}{I}_{α} \\ {I}_{β} \\ {I}_{γ}\end{matrix} ) , \\ {illumination}^{->} = ( \begin{matrix}{illumination}_{α} \\ {illumination}_{β} \\ {illumination}_{γ}\end{matrix} ) , \\ {{I}^{->}}_{α} = ( \begin{matrix}{I}_{α} ( {f}_{1} ) \\ {I}_{α} ( {f}_{2} ) \\ {I}_{α} ( {f}_{3} )\end{matrix} ) , \\ and \text{:} {M}_{α} = ( \begin{matrix}- 1 & - 1 & - 1 \\ - 1 \text{/} {R}_{αβ} ( {f}_{1} ) & - 1 \text{/} {R}_{αβ} ( {f}_{2} ) & - 1 \text{/} {R}_{αβ} ( {f}_{3} ) \\ - 1 \text{/} {R}_{αγ} ( {f}_{1} ) & - 1 \text{/} {R}_{αγ} ( {f}_{2} ) & - 1 \text{/} {R}_{αγ} ( {f}_{3} )\end{matrix} )$$

By inverting the matrix and corresponding application, the desired result is obtained:

\vec{I_{α}}=M_{α}⁻¹*[\vec{I}−\vec{illumination}] (Equation 2a)

As the observed dyes or fluorochromes and detectors have a very broad spectral bandwidth, matrix inversion is generally possible.

Similar matrices M_{β} and M_{γ}

and therefore also similar matrix equations can be formulated for the remaining components, for the corresponding calculation of

\vec{I_{β}}=M_{β}⁻¹*[\vec{I}−\vec{illumination}] (Equation 2b)

\vec{I_{γ}}=M_{γ}⁻¹*[\vec{I}−\vec{illumination}] (Equation 2b)

wherein

$${{I}^{->}}_{β} = ( \begin{matrix}{I}_{β} ( {f}_{1} ) \\ {I}_{β} ( {f}_{2} ) \\ {I}_{β} ( {f}_{3} )\end{matrix} ) and {{I}^{->}}_{γ} = ( \begin{matrix}{I}_{γ} ( {f}_{1} ) \\ {I}_{γ} ( {f}_{2} ) \\ {I}_{γ} ( {f}_{3} )\end{matrix} )$$

Matrix Equations 2 can be solved pixel-by-pixel using an algorithm which can easily be implemented using a program to achieve the colour unmixing of the recorded multicolour image to form the single-colour images each separately showing the absorption contributions of the dyes f1, f2 and f3.

Equations 1 may also be written as

Illumination_{α}−I_{α}=I_{α}*=I_{α}(f₁)+I_{α}(f₂)+I_{α}(f₃)

Illumination_{β}−I_{β}=I_{β}*=I_{β}(f₁)+I_{β}(f₂)+I_{β}(f₃)

Illumination_{γ}−I_{γ}=I_{γ}*=I_{γ}(f₁)+I_{γ}(f₂)+I_{γ}(f₃) (Equations 3)

These equations correspond formally to the system of linear equations to be solved for “spectral unmixing” of three-coloured fluorescence images, so alternatively an algorithm provided for the spectral unmixing of fluorescence images with spectral contributions of at least three different fluorochromes can be used to unmix the colours of the recorded transmission multicolour image. The variables I_{α}*, I_{β}* and I_{γ}* which can be determined by subtraction from the detected intensities I_{α}, I_{β} and I_{γ} and the maximum possible intensity values I_{α}^{MAX}, I_{β}^{MAX} and I_{γ}^{MAX} then enter into this algorithm as fictitious intensities which are detected pixel-by-pixel for the colour channels.

### Possible Applications of the Method

The described method can be used, for example, to separate images of biological objects that were recorded with various spectral components. Intended, for example, are structures which have been dyed with various dyes or have their natural colour in histological cuttings recorded using, for example, a digital colour camera, or various emission wavelengths recorded using colour filters, or various illumination colours recorded, for example, using a black-and-white camera, or a combination of these types of image generation.

The method may expediently be used for image processing in the sense of “preprocessing” for automatic cell recognition, counting, etc.

### Limitations of the Method

### Colocalisations

Unlike fluorescent structures, dyed or natural-coloured structures are generally not transparent to differently coloured structures located thereabove or therebelow. The detected colour information of a structure is therefore dependent on the presence of other coloured structures at the same point. Quantitative evaluation of the “unmixed” images is possible only if this effect can be disregarded. However, in most cases this will not be possible. The linear subtractive approach on which the method is based is generally at least a sufficiently good approximation of the actual conditions to allow the morphological properties, which are especially important for many applications, of a coloured structure or mutually overlapping structures of various colours to be represented. Additional information can therefore generally be inferred from the “unmixed” image or the evaluation of the multicolour image is at least greatly facilitated on the basis of the colour information contained. Moreover, often all that matters is the ascertainment of colocalisations, and this is certainly facilitated using the method.

Restriction of the Number of “Original Colours” which can be Unmixed

Generally, only for three different colour channels can only three different original colours be extracted from a multicolour image using the described unmixing method, as only a system of linear equations comprising three linearly independent equations can be formulated on the basis of the intensities detected for three colour channels. This limitation can be overcome using a specific detector assembly comprising more than three colour channels which spectrally do not overlap one another or overlap one another only slightly, so more than three linearly independent equations can be formulated. Another possibility is to record a plurality of single-colour images in transmitted light using narrow-band illumination light at differing illumination wavelengths so, to a certain extent spectrally selectively, the absorption is detected at various wavelengths and the resulting single-colour images each correspond to an independent colour channel, so more than three equations which are linearly independent of one another can, in turn, be formulated on the basis of more than three single-colour images of this type.

Three different-coloured structures may therefore be separated from one another in a colour photograph on the basis of three colour channels normally present in a colour camera. The equipment costs required for overcoming this limitation would generally be disproportionate to the restrictions placed on the method by colocalisations. If more than three structures are to be separated from one another, fluorescence-based examination methods, especially wide-field fluorescence microscopy, are, on the other hand, appropriate.

### Exemplary Unmixing Results

With reference to the embodiment according to FIG. 1, FIG. 2 represents a transmission microscopic multicolour image which was recorded by the colour camera 16 and is represented pixel-by-pixel by three colour channels. There may be seen three different coloured structures S1, S2 and S3 which overlap, so mixed colours form in the overlap region. The various colours are represented by differing forms of hatching. The structures are sufficiently transparent to allow all structures to be seen even in the overlap region.

FIGS. 3, 4 and 5 show single-colour images resulting from the unmixing of the multicolour image according to FIG. 2 using the above-specified method. The single-colour images show the respective structure S1 or S2 or S3 to facilitate comparison with the multicolour image itself in the same colour as in the multicolour image outside the overlap region, and the representation corresponds again to a bright-field transmission microscopic photograph in which the structure is shown against a bright background. The reduction in image intensity of the bright background to form an image of the structure is the measure of the absorption which occurs. Alternatively, the single-colour images could also be represented in the manner of fictitious fluorescence images in which an image of the structure is formed against a dark background, the increase in intensity of the dark background to form an image of the structure representing the absorption which has occurred.

For the schematic example shown in the present case, it was assumed that the linear subtractive approach is highly appropriate, so the three structures S1, S2 and S3 are optimally separable and the single-colour images therefore each show only one of the structures.

FIG. 6 is a greyscale representation of a transmission microscopic photograph of a dyed clematis cutting. The colours occurring mainly against a bright background are blue/turquoise blue, red and dark blue.

Colour mixing using the above-described method produces the single-colour images according to FIGS. 7, 8 and 9. FIG. 7 shows the result of the unmixing in relation to the colour contributions which in FIG. 6 appear to be red, illustrated in the same red colour against a bright background and represented in the present case as a greyscale image.

FIG. 8 shows the result of the unmixing in relation to the colour contributions which in FIG. 6 appear to be bright to mid-blue, illustrated in the same blue tone against a bright background and represented in the present case as a greyscale image.

FIG. 9 shows the results of the unmixing in relation to dark blue colour contributions in FIG. 6, illustrated in the same blue tone against a bright background and represented in the present case as a greyscale image.

The described and exemplified unmixing of original colours of a multicolour image facilitates the identification of structures of an object to be examined and frequently provides additional information which cannot be inferred or can be inferred only with difficulty from the original multicolour image. The invention can also be applied to multicolour images obtained from fluorescence-based examinations, in particular from fluorescence microscopic photographs.

1. Method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels,
a) on a superimposition, taking place simultaneously, optionally in the detection, or successively, of at least two original colours which are each allocated or can at least approximately be allocated to at least one property or structure of the object or the sample and/or at least one dye, which is inherently present or added by a colouring treatment, of the object or the sample, the superimposition taking place
in the sense of a subtractive colour mixing and/or based on an absorption and/or reflection and/or scattering, taking place during an illumination of the object or the sample with optical radiation, of various spectral contributions of optical radiation and then simultaneous and/or temporally successive detection of various spectral contributions, which have optionally been determined by a respective detection wavelength band and remained in the optical radiation after the absorption or reflection or scattering in transmission, of optical radiation and/or various spectral contributions, which have optionally been determined by a respective detection wavelength band and reflected or scattered by the object or the sample, of optical radiation, wherein the original colours are allocated or can be allocated to absorbed or detected contributions of optical radiation in the sense of an off-colour respectively allocated to the respective contribution of optical radiation or in the sense of a visual colour impression respectively resulting from a hypothetical or actual visual perception of the respective contribution of optical radiation,
and
b) on a pixel-by-pixel representation of mixed colours, resulting from the superimposition of the original colours, by the intensity pixels of the colour channels;
characterised in that
the method includes the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions of an original colour for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels,
the single-colour images being generated on the basis of characteristic intensity ratios which are assumed or predetermined or obtained from a calibration or derived from the multicolour image and represent ratios between at least two preferably additive or subtractive intensity contributions which are each allocated to another of the colour channels or intensity contents of the original colours corresponding to a pixel-by-pixel representation of the original colour by the intensity pixels or in the intensity pixels of the colour channels.

2. A method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels,
a) on a superimposition, taking place simultaneously, or successively, of at least two colour channel-based original intensity values which are each allocated or at least being allocateable to at least one property or structure of the object or the sample and/or at least one dye, which is inherently present or added by a colouring treatment, of the object or the sample, the superimposition taking place,
based on an absorption, reflection, scattering, or any combinations of them, taking place during an illumination of the object or the sample with optical radiation, of various spectral contributions of optical radiation and then at least one of a simultaneous detection and temporally successive detection of various spectral contributions, which remained in the optical radiation after the absorption or reflection or scattering in transmission, of optical radiation and/or various spectral contributions, reflected or scattered by the object or the sample, of optical radiation, wherein the original intensity values, which enter into the superimposition, represent absorbed or detected contributions of optical radiation;
and
b) on a pixel-by-pixel representation of colour channel-based sequential intensity values, resulting from the superimposition of the original intensity values, by the intensity pixels of the colour channels;
characterised in that
the method includes the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions by the original intensity values for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels,
the single-colour images being generated on the basis of characteristic intensity ratios which are assumed or predetermined or obtained from a calibration or derived from the multicolour image and represent ratios between at least two original intensity values which are each allocated to another of the colour channels and are allocated to the same property or structure of the object or the sample or the same dye of the object or the sample.

3. Method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels,
a′) on a superimposition, taking place simultaneously, optionally in the detection, or successively, of at least two original colours which are each allocated or can at least approximately be allocated to at least one property or structure of the object or the sample and/or at least one dye, which is inherently present or added by a colouring treatment, of the object or the sample, the superimposition taking place
in the sense of an additive colour mixing of the original colours and/or based on an emission emanating from the object or the sample and then simultaneous and/or temporally successive detection of various spectral contributions, which have optionally been determined by a respective detection wavelength band, of optical radiation, wherein the original colours are allocated or can be allocated to detected contributions of optical radiation in the sense of an off-colour respectively allocated to the respective contribution of optical radiation or in the sense of a visual colour impression respectively resulting from a hypothetical or actual visual perception of the respective contribution of optical radiation,
and
b) on a pixel-by-pixel representation of mixed colours, resulting from the superimposition of the original colours, by the intensity pixels of the colour channels;
characterised in that
the method includes the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions of an original colour for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels,
the single-colour images being generated on the basis of characteristic intensity ratios which are assumed or predetermined or obtained from a calibration or derived from the multicolour image and represent ratios between at least two preferably additive intensity contributions which are each allocated to another of the colour channels or intensity contents of the original colours corresponding to a pixel-by-pixel representation of the original colour by the intensity pixels or in the intensity pixels of the colour channels.

4. A method for examining objects or samples, wherein optical radiation which emanates from at least one object or at least one sample or is passed through the object or the sample is detected in a locally resolved manner and, based on the detection, a multicolour image, defined by intensity pixels (I_{α}(x,y), I_{β}(x,y), I_{γ}(x,y)) of at least two colour channels (α, β, γ), of the object or the sample is generated in such a way that the multicolour image is respectively based, at least for the intensity pixels of at least one group of intensity pixels,
a′) on a superimposition, taking place simultaneously, or successively, of at least two colour channel-based original intensity values which are each allocated or can at least approximately be allocated to at least one property or structure of the object or the sample and/or at least one dye, which is inherently present or added by a colouring treatment, of the object or the sample, the superimposition taking place,
based on an emission emanating from the object or the sample and then at least one of a simultaneous detection and temporally successive detection of various spectral contributions, of optical radiation, wherein the original intensity values, which enter into the superimposition, represent detected contributions of optical radiation;
and
b) on a pixel-by-pixel representation of colour channel-based sequential intensity values, resulting from the superimposition of the original intensity values, by the intensity pixels of the colour channels;
characterised in that
the method includes the step, for identifying properties or structures of the object or the sample and/or for identifying dyes, which are inherently present or added by the colouring treatment, of the object or the sample, of generating from the multicolour image, defined by the intensity pixels (I_{α}(x,y), I_{β}(x,y), I_{γ}(x,y)) of the at least two colour channels (α, β, γ), of the object or the sample a plurality of single-colour images which each represent the pixel-by-pixel superimposition contributions by the original intensity values for at least one colour channel and are each defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels,
the single-colour images being generated on the basis of characteristic intensity ratios which are assumed or predetermined or obtained from a calibration or derived from the multicolour image and represent ratios between at least two original intensity values which are each allocated to another of the colour channels and are allocated to the same property or structure of the object or the sample or the same dye of the object or the sample.

5. Method for generating a plurality of single-colour images from a multicolour image, defined by intensity pixels (I_{α}(x,y), I_{β}(x,y), I_{γ}(x,y)) of at least two colour channels (α, β, γ), of a sample or an object, for identifying properties or structures of the object or the sample and/or for identifying dyes, which are inherently present or added by a colouring treatment, of the object or the sample, the single-colour images being defined by intensity pixels of only one of the colour channels or by intensity pixels of a plurality of the colour channels having the same intensity ratio, for all intensity pixels, between the colour channels or by intensity pixels of only one resulting colour channel corresponding to a defined combination of the colour channels,
the multicolour image being based, at least for the intensity pixels of at least one group of intensity pixels, on a respective superimposition of superimposition contributions allocated to various original colours, in particular at least approximately additive intensity contributions or intensity contents and/or at least approximately subtractive intensity contributions or intensity contents, the multicolour image obtained, in particular, in accordance with the preamble of at least one of claims 1 to 4,
characterised in that
the single-colour images represent superimposition contributions allocated to various original colours and are generated on the basis of characteristic intensity ratios which are assumed or predetermined or obtained from a calibration or derived from the multicolour image and represent ratios between at least two intensity contributions or intensity contents which are each allocated to another of the colour channels and are allocated to the same property or structure of the object or the sample or the same dye of the object or the sample.

6. Method according to claim 5, characterised in that the single-colour images are generated in accordance with the characterising part of at least one of claims 1 to 4.

7. Method according to at least one of the preceding claims, characterised in that a respective superimposition contribution is to be understood as an intensity content or intensity contribution for a respective colour channel, which intensity content or intensity contribution can be traced back, using a linear, subtractive or additive approach in the superimposition, to a respective property or structure or a respective dye of the object or the sample.

8. Method according to claim 7, in particular as dependent at least on either claim 1 or claim 2, characterised in that a respective superimposition contribution is to be understood, using a linear, subtractive approach, as an intensity content, removed from the optical radiation in transmission by absorption resulting from a respective property or by a respective structure or a respective dye of the object or the sample, for a respective colour channel.

9. Method according to claim 7, in particular as dependent at least on either claim 3 or claim 4, characterised in that a respective superimposition contribution is to be understood, using a linear, additive approach, as an additive intensity contribution, emanating as a result of a respective property of the object or the sample or of a respective structure or a respective dye of the object or the sample, for a respective colour channel, optionally is to be understood as an additive intensity contribution resulting from a stimulation of a dye and emission, resulting therefrom, of optical radiation by the dye for the respective colour channel.

10. Method according to at least one of the preceding claims, characterised in that the multicolour image of the object or the sample is defined by intensity pixels (I_{α}(x,y), I_{β}(x,y), I_{γ}(x,y)) of at least three colour channels (α, β, γ).

11. The method according to claim 2, characterised in that the optical radiation is detected simultaneously or in temporal succession in at least two, preferably at least three different detection wavelength bands, which are spectrally offset from one another, of a detector assembly, and that the detection wavelength bands are each allocated to one of a plurality of detection colour channels of the detector assembly which is configured as a colour image detector assembly, wherein the detection colour channels are allocated to various primary colours which correspond to the detection wavelength bands and from which, in accordance with an intensity value which is detected pixel-by-pixel for the respective detection colour channel, a colour, which is detected for the respective pixel or a group of pixels each allocated to one of the colour channels, can be additively mixed.

12. Method according to claim 11, characterised in that the detection wavelength bands are each allocated to one of a plurality of detection colour channels of the detector assembly which is configured as a colour image detector assembly, wherein the detection colour channels are allocated to various primary colours which correspond to the detection wavelength bands and from which, in accordance with an intensity value which is detected pixel-by-pixel for the respective detection colour channel, a colour, which is detected for the respective pixel or a group of pixels each allocated to one of the colour channels, can be additively mixed.

13. Method according to claim 12, characterised in that the colour channels of the detector assembly correspond to the colour channels on the basis of which the multicolour image is defined, so the detector assembly directly prepares the multicolour image or prepares at least one intermediate multicolour image from which the multicolour image is generated without being converted to a colour illustration based on other primary colours.

14. Method according to claim 12, characterised in that the colour channels of the detector assembly differ from the colour channels on the basis of which the multicolour image is defined, so the detector assembly prepares at least one intermediate multicolour image from which the multicolour image is generated while being converted to a colour illustration based on the representation of the superimposition, in particular the representation of the primary colours on which mixed colours or sequential intensity values are based.

15. The method according to claim 2, characterised in that the superimposition includes a simultaneous or successive detection of various spectral contributions of optical radiation based on the same illumination of the object or the sample with optical radiation.

16. The method according to claim 15, characterised in that the superimposition includes a simultaneous or successive detection of various spectral contributions of optical radiation based on the same illumination of the object or the sample with multispectral optical radiation.

17. The method according to claim 2, characterised in that the generation of the single-colour images, representing the superimposition contributions, for each pixel of the group or partial group includes mathematical operations which include the solution to a system of linear equations comprising a plurality of unknown quantities by methods of linear algebra or ratio methods or correspond mathematically to the exact or approximate solution to a system of equations of this type.

18. Method according to claim 17, characterised in that the number of linear equations per pixel corresponds at most to the number of colour channels.

19. The method according to claim 43 characterised in that the generation of the single-colour images is based on a system of equations, of which the equations for three colour channels generally have the following form or can be brought into the following form:
I_{α}(x,y)=I_{α}(x,y,f1)+I_{α}(x,y,f2)+I_{α}(x,y,f3)
I_{β}(x,y)=I_{β}(x,y,f1)+I_{β}(x,y,f2)+I_{β}(x,y,f3)
I_{γ}(x,y)=I_{γ}(x,y,f1)+I_{γ}(x,y,f2)+I_{γ}(x,y,f3)
wherein I_{α}(x,y), I_{β}(x,y), I_{γ}(x,y) are the intensity values of the intensity pixels of the multicolour image for the three colour channels α, β and γ, the coordinates x,y identify a respective pixel and the terms to the right of the equals signs each specify an additive superimposition contribution to the intensity value of the respective colour channel α or β or γ resulting from a property or structure or a dye f1 or f2 or f3 of the sample or the object.

20. The method according to claim 17, characterised in that generation of the single-colour images is based on a system of equations, of which the equations for three colour channels generally have the following form or can be brought into the following form:
I_{α}(x,y)=I_{α}^{MAX}−I_{α}(x,y,f1)−I_{α}(x,y,f2)−I_{α}(x,y,f3)
I_{β}(x,y)=I_{β}^{MAX}−I_{β}(x,y,f1)−I_{β}(x,y,f2)−I_{β}(x,y,f3)
I_{γ}(x,y)=I_{γ}^{MAX}−I_{γ}(x,y,f1)−I_{γ}(x,y,f2)−I_{γ}(x,y,f3)
wherein I_{α}(x,y), I_{β}(x,y), I_{γ}(x,y) are the intensity values of the intensity pixels of the multicolour image for the three colour channels α, β and γ, the coordinates x,y identify a respective pixel, the terms I_{α}^{MAX}, I_{β}^{MAX}, I_{γ}^{MAX} specify an intensity value, which is the maximum possible value for a given examining situation, for the respective colour channel α or β or γ and the remaining terms to the right of the equals signs each specify a subtractive superimposition contribution to the intensity value of the respective colour channel α or β or γ resulting from a property or structure or a dye f1 or f2 or f3 of the sample or the object.

21. The method according to claim 20, characterised in that the terms I_{α}^{MAX}, I_{β}^{MAX}, I_{γ}^{MAX} which specify a maximum possible intensity value for the colour channels α, β and γ, are determined from the multicolour image, preferably by determining a maximum pixel intensity for the respective colour channel from all intensity pixels.

22. The method according to claim 20, characterised in that the system of equations for the terms I_{α}(x,y,f1), I_{β}(x,y,f1), I_{γ}(x,y,f1) and/or for the terms I_{α}(x,y,f2), I_{β}(x,y,f2), I_{γ}(x,y,f2) and/or for the terms I_{α}(x,y,f3), I_{β}(x,y,f3), I_{γ}(x,y,f3) is solved on the basis of characteristic intensity ratios
R_{αβ}(f1)=I_{α}(f1)/I_{β}(f1)
R_{αγ}(f1)=I_{α}(f1)/I_{γ}(f1)
R_{αβ}(f2)=I_{α}(f2)/I_{β}(f2)
R_{αγ}(f2)=I_{α}(f2)/I_{γ}(f2)
R_{αβ}(f3)=I_{α}(f3)/I_{β}(f3)
R_{αγ}(f3)=I_{α}(f3)/I_{γ}(f3)
or characteristic intensity ratios which can be derived therefrom and specify the ratio between two superimposition contributions Iₐ( ), I_{b}( ), contributing subtractively to differing colour channels a, b, resulting from the same property or structure or the same dye f1 or f2 or f3 of the sample or the object, a, b each referring to two different channels of the colour channels α, β, γ.

23. The method according to claim 22, characterised in that the characteristic intensity ratios are determined from the multicolour image, on the basis of an identification of image regions which are based, without superimposition of a plurality of subtractive superimposition contributions for each colour channel, merely on subtractive intensity contributions I_{α}(x,y,f1), I_{β}(x,y,f1), I_{γ}(x,y,f1) or I_{α}(x,y,f2), I_{β}(x,y,f2), I_{γ}(x,y,f2) or I_{α}(x,y,f3), I_{β}(x,y,f3), I_{γ}(x,y,f3) resulting from precisely one property or structure or precisely one dye f1 or f2 or f3 of the sample or the object.

24. The method according to claim 22, characterised in that the characteristic intensity ratios are determined from calibration multicolour images generated for calibration samples or calibration objects, the calibration samples or calibration objects being chosen or prepared in such a way that they are based, at least in an image region of the calibration multicolour image without superimposition of a plurality of subtractive superimposition contributions for each colour channel, merely on subtractive intensity contributions I_{α}(x,y,f1), I_{β}(x,y,f1), I_{γ}(x,y,f1) or I_{α}(x,y,f2), I_{β}(x,y,f2), I_{γ}(x,y,f2) or I_{α}(x,y,f3), I_{β}(x,y,f3), I_{γ}(x,y,f3) resulting from precisely one property or structure or precisely one dye f1 or f2 or f3 of the calibration sample which is thus representative of the sample or the calibration object which is thus representative of the object.

25. A method for examining objects or samples, wherein, of an object or a sample in transmission for a plurality of different detection wavelength bands which are spectrally offset from one another, a respective image, indicating in intensity values detected in a locally resolved manner a weakening of optical radiation passing through the object or the sample in the respective detection wavelength band resulting from absorption, of the object or the sample is recorded and wherein there are generated, on the basis of characteristic intensity ratios which are assumed or predetermined or obtained from a calibration or derived from a plurality of the images, images which result from the images and represent the absorption contents based on various properties, structures, or any combinations of them, absorbing the optical radiation, of the object or the sample and/or based on various dyes, absorbing the optical radiation, of the object or the sample.

26. The method according to claim 25, characterised in that the generation of the resulting images includes mathematical operations which include the solution to a system of linear equations comprising a plurality of unknown quantities by methods of linear algebra or ratio methods or correspond mathematically to the exact or approximate solution to a system of equations of this type.

27. The method according to claim 25, characterised in that the generation of the resulting images is based on a system of equations, of which the equations for N detection wavelength bands D1 to DN generally have the following form or can be brought into the following form:
I_{D1}(x,y)=I_{D1}^{MAX}−I_{D1}(x,y,f1)−I_{D1}(x,y,f2)− . . . −I_{D1}(x,y,fN)
I_{D2}(x,y)=I_{D2}^{MAX}−I_{D2}(x,y,f1)−I_{D2}(x,y,f2)− . . . −I_{D1}(x,y,fN)
. . .
I_{DN}(x,y)=I_{DN}^{MAX}−I_{DN}(x,y,f1)−I_{DN}(x,y,f2)− . . . −I_{DN}(x,y,fN)
wherein I_{D1}(x,y), . . . , I_{DN}(x,y) are the intensity values, detected in a locally resolved manner, of each of the recorded images, x,y are location coordinates or identify a respective pixel of the recorded image, the terms I_{D1}^{MAX}, . . . , I_{DN}^{MAX}, specify an intensity value, which is the maximum possible value for a given examining situation, for the respective detection wavelength band D1 to DN and the remaining terms to the right of the equals signs each specify a subtractive superimposition contribution to the intensity value of the respective recorded image resulting from a property or structure or a dye of various dyes f1 to fN of the sample or the object.

28. The method according to claim 27, characterised in that the terms I_{D1}^{MAX}, . . . , I_{DN}^{MAX}, specifying a maximum possible intensity value for the detection wavelength bands D1 to DN, are determined from the respective recorded image, preferably by determining a maximum intensity.

29. The method according to claim 27, characterised in that the system of equations is solved on the basis of characteristic intensity ratios
R_{D1D2}(f1)=I_{D1}(f1)/I_{D2}(f1)
. . .
R_{D1DN}(f1)=I_{D1}(f1)/I_{DN}(f1)
R_{D1D2}(f2)=I_{D1}(f2)/I_{D2}(f2)
. . .
R_{D1DN}(f2)=I_{D1}(f2)/I_{DN}(f2)
. . .
R_{D1D2}(fN)=I_{D1}(fN)/I_{D2}(fN)
. . .
R_{D1DN}(fN)=I_{D1}(fN)/I_{DN}(fN)
or characteristic intensity ratios which can be derived therefrom and specify the ratio between two absorption contents, contributing subtractively to various detection wavelength bands, resulting from the same property or structure or the same dye of the sample or the object.

30. The method according to claim 29, characterised in that the characteristic intensity ratios are each determined from two of the recorded images, preferably on the basis of an identification of image regions based merely on absorption contents resulting from precisely one property or structure or precisely one dye of the sample or the object.

31. The method according to claim 29, characterised in that the characteristic intensity ratios are determined from calibration images recorded for calibration samples or calibration objects, wherein the calibration samples or calibration objects are selected or prepared so as to be based, at least in an image region of the calibration image, merely on absorption contents resulting from precisely one property or structure or precisely one dye of the calibration sample which is thus representative of the sample or the calibration object which is thus representative of the object.

32. Method according to any one of the preceding claims, at least as dependent on any one of claims 1 to 4 or on claim 25, characterised in that the optical radiation is detected in a locally resolved manner using a microscope.

33. Method according to claim 32, characterised in that the multicolour image is a microscopic transmission multicolour image or bright-field multicolour image or dark-field multicolour image of the object or the sample or is based on at least one microscopic transmission multicolour image or bright-field multicolour image or dark-field multicolour image of the object or the sample or a plurality of microscopic transmission multicolour images or bright-field images or dark-field images, optionally single-colour or black-and-white images, of the object or the sample, or in that the recorded images are microscopic transmission images or bright-field images or dark-field images of the object or the sample.

34. Method according to any one of the preceding claims, characterised in that the sample is a biological sample, for example a histological cutting, or a biological object.

35. Method according to any one of the preceding claims, at least as dependent on any one of claims 1 to 4 or on claim 25, characterised in that the method includes the step of colouring at least one structure of the sample or the object with at least one dye.

36. Method according to any one of the preceding claims, characterised in that the colour channels or detection wavelength bands correspond to colour channels for representing the multicolour image or the recorded images on an electronic screen, for example RGB colour channels.

37. An arrangement for examining objects or samples, comprising:
an image memory for storing a multicolour image, defined by intensity pixels (I_{α}(x,y), I_{β}(x,y), I_{γ}(x,y)) of at least two colour channels (α, β, γ), of a sample or an object, the multicolour image being respectively based, at least for the intensity pixels of at least one group of intensity pixels, on a superimposition of superimposition contributions allocated to various original colours,
an image processing unit which operates on the intensity pixels of the multicolour image and breaks the multicolour image down into single-colour images which it stores in the image memory, the single-colour image being defined by intensity pixels of only one of the colour channels or by intensity pixels of a plurality of the colour channels having an intensity ratio, which is the same for all intensity pixels, between the colour channels or by intensity pixels of only one resulting colour channel corresponding to a defined combination of the colour channels,
characterised in that
the image processing unit is configured or programmed to generate the single-colour images, which represent superimposition contributions allocated to various original colours, on the basis of characteristic intensity ratios which are assumed or predetermined or obtained from a calibration or derived from the multicolour image and represent ratios between at least two intensity contributions or intensity contents which are each allocated to another of the colour channels and are allocated to the same property or structure of the object or the sample or the same dye of the object or the sample and in that the arrangement comprises means for generating the multicolour image, which comprise a microscope and a local resolution detector assembly.

38. Arrangement according to claim 37, characterised by means for generating the multicolour image.

39. Arrangement according to claim 38, characterised in that the means comprise a microscope and a local resolution detector assembly.

40. Computer program product for carrying out the method according to any one of claims 1 to 36.

41. Computer program product according to claim 40, in particular in the form of a program which can be stored on a data carrier or downloaded from a server, for example via the Internet, which program can be executed by a computer and carries out during execution of the program by a processor means (36) of the computer, on the basis of a multicolour image stored in a storage means (32) of the computer, the method according to claim 5 or the generation of the single-colour images from the multicolour image according to the characterising part of at least one of claims 1 to 4.

42. The method according to claim 4, characterised in that the optical radiation is detected simultaneously or in temporal succession in at least two different detection wavelength bands, which are spectrally offset from one another, of a detector assembly and that the detection wavelength bands are each allocated to one of a plurality of detection colour channels of the detector assembly which is configured as a colour image detector assembly, wherein the detection colour channels are allocated to various primary colours which correspond to the detection wavelength bands and from which, in accordance with an intensity value which is detected pixel-by-pixel for the respective detection colour channel, a colour, which is detected for the respective pixel or a group of pixels each allocated to one of the colour channels, can be additively mixed.

43. The method according to claim 4, characterised in that the generation of the single-colour images, representing the superimposition contributions, for each pixel of the group or partial group includes mathematical operations which include the solution to a system of linear equations comprising a plurality of unknown quantities by methods of linear algebra or ratio methods or correspond mathematically to the exact or approximate solution to a system of equations of this type.

44. The method according to claim 19, characterised in that the system of equations for the terms I_{α}(x,y,f1), I_{β}(x,y,f1), I_{γ}(x,y,f1) and/or for the terms I_{α}(x,y,f2), I_{β}(x,y,f2), I_{γ}(x,y,f2) and/or for the terms I_{α}(x,y,f3), I_{β}(x,y,f3), I_{γ}(x,y,f3) is solved on the basis of characteristic intensity ratios
R_{αβ}(f1)=I_{α}(f1)/I_{β}(f1)
R_{αγ}(f1)=I_{α}(f1)/I_{γ}(f1)
R_{αβ}(f2)=I_{α}(f2)/I_{β}(f2)
R_{αγ}(f2)=I_{α}(f2)/I_{γ}(f2)
R_{αβ}(f3)=I_{α}(f3)/I_{β}(f3)
R_{αγ}(f3)=I_{α}(f3)/I_{γ}(f3)
or characteristic intensity ratios which can be derived therefrom and specify the ratio between two superimposition contributions Iₐ( ), I_{b}( ), contributing additively to differing colour channels a, b, resulting from the same property or structure or the same dye f1 or f2 or f3 of the sample or the object, a, b each referring to two different channels of the colour channels α, β, γ.

45. The method according to claim 44, characterised in that the characteristic intensity ratios are determined from the multicolour image, on the basis of an identification of image regions which are based, without superimposition of a plurality of additive superimposition contributions for each colour channel, merely on additive intensity contributions I_{α}(x,y,f1), I_{β}(x,y,f1), I_{γ}(x,y,f1) or I_{α}(x,y,f2), I_{β}(x,y,f2), I_{γ}(x,y,f2) or I_{α}(x,y,f3), I_{β}(x,y,f3), I_{γ}(x,y,f3) resulting from precisely one property or structure or precisely one dye f1 or f2 or f3 of the sample or the object.

46. The method according to claim 44, characterised in that the characteristic intensity ratios are determined from calibration multicolour images generated for calibration samples or calibration objects, the calibration samples or calibration objects being chosen or prepared in such a way that they are based, at least in an image region of the calibration multicolour image without superimposition of a plurality of additive superimposition contributions for each colour channel, merely on additive intensity contributions I_{α}(x,y,f1), I_{β}(x,y,f1), I_{γ}(x,y,f1), or I_{α}(x,y,f2), I_{β}(x,y,f2), I_{γ}(x,y,f2) or I_{α}(x,y,f3), I_{β}(x,y,f3), I_{γ}(x,y,f3) resulting from precisely one property or structure or precisely one dye f1 or f2 or f3 of the calibration sample which is thus representative of the sample or the calibration object which is thus representative of the object.
